(19) United States
(12) Patent Application Publication
(10) Pub. No.: US 2018/0302418 A1
(43) Pub. Date: Oct. 18, 2018

(54) METHOD AND SYSTEM FOR DETECTION AND INTERFERENCE OF NETWORK RECONNAISSANCE

(71) Applicant: CYBERSECURITY DEFENSE SOLUTIONS, LLC, Ft. Myers, FL (US)

(72) Inventor: Gregory P. SCASNY, Ft. Myers, FL (US)

(73) Assignee: CYBERSECURITY DEFENSE SOLUTIONS, LLC, Ft. Myers, FL (US)

(21) Appl. No.: 15/945,241

(22) Filed: Apr. 4, 2018

Related U.S. Application Data
(60) Provisional application No. 62/484,549, filed on Apr. 12, 2017.
(60) Provisional application No. 62/610,576, filed on Dec. 27, 2017.

(51) Int. Cl. H04L 29/06; H04L 29/12; H04L 12/24

(52) U.S. Cl. CPC H04L 63/1416; H04L 41/12; H04L 61/103; H04L 63/1491

(57) ABSTRACT

A method for detecting unauthorized network activity includes: establishing, by a reconnaissance detection device, communication with a communication network comprised of a plurality of networked devices; emulating, by the reconnaissance detection device, a known networked device; receiving, by the reconnaissance detection device, one or more network communications intended for the known networked device; identifying, by the reconnaissance detection device, at least a device identifier associated with a source device of the received one or more network communications; and transmitting, by the reconnaissance detection device, an alert via an application programming interface, wherein the alert includes at least the identified device identifier.

### FIELD

The present disclosure relates to the detection, alerting, and interference with adversaries attempting reconnaissance of a computing network.

### BACKGROUND

The attack methodology used by hackers and adversaries to infiltrate networks and exfiltrate data or execute other actionable objectives is an industry accepted perspective known as the Cyber Attack Lifecycle, which consists of the following stages: reconnaissance, weaponization, delivery, exploitation, command and control, execution on objectives, and persistence. When attempting to detect cyber-attacks related to reconnaissance of a computing network, traditionally solutions utilize signatures of known bad software (e.g., viruses, malware, known attacker programs, etc.) and/or network traffic, or by utilizing machine learning or endpoints. However, these solutions require prior knowledge of the sources of such attacks and are thus reactive rather than proactive. In cases where sensitive data may be stored on the network, a reactive solution does little to prevent compromise via an unknown attack source.

Thus, there is a need for a technological solution to detect for, alert of, and interfere with attempted reconnaissance of a computing network.

### SUMMARY

The present disclosure provides a description of systems and methods for detection, alerting, and interference of computing network reconnaissance.

A method for detecting unauthorized network activity includes: establishing, by a reconnaissance detection device, communication with a communication network comprised of a plurality of networked devices; emulating, by the reconnaissance detection device, a known networked device; receiving, by the reconnaissance detection device, one or more network communications intended for the known networked device; identifying, by the reconnaissance detection device, at least a device identifier associated with a source device of the received one or more network communications; and transmitting, by the reconnaissance detection device, an alert via an application programming interface, wherein the alert includes at least the identified device identifier.

A method for identifying unknown networked devices includes: identifying, by a reconnaissance detection device, a plurality of networked devices interfaced with a communication network, and, for each of the networked devices, a device identifier; electronically transmitting, by the reconnaissance detection device, at least the device identifier for each of the plurality of networked devices to an external device; receiving, by the reconnaissance detection device, a specific device identifier from the external device; electronically transmitting, by the reconnaissance detection device, a request packet to a specific networked device associated with the specific device identifier in the plurality of networked devices; receiving, by the reconnaissance detection device, a reply packet from the specific networked device; and repeating, by the reconnaissance detection device, transmitting the request packet and receiving the reply packet until one of: receiving, by the reconnaissance detection device, a stop instruction from the external device, and elapsing of a predetermined period of time after transmission of a request packet to the specific networked device without receipt of a reply packet from the specific networked device.

A system for detecting unauthorized network activity includes: a communication network; a plurality of networked devices interfaced with the communication network; and a reconnaissance detection device configured to establish communication with a communication network comprised of a plurality of networked devices, emulate a known networked device, receive one or more network communications intended for the known networked device, identify at least a device identifier associated with a source device of the received one or more network communications, and transmit an alert via an application programming interface, wherein the alert includes at least the identified device identifier.

A system for identifying unknown networked devices includes: a communication network; a plurality of networked devices interfaced with the communication network; and a reconnaissance detection device configured to identify the plurality of networked devices interfaced with the communication network, and, for each of the networked devices, a device identifier, electronically transmit at least the device identifier for each of the plurality of networked devices to an external device, receive a specific device identifier from the external device, electronically transmit a request packet to a specific networked device associated with the specific device identifier in the plurality of networked devices, receive a reply packet from the specific networked device, and repeat transmitting the request packet and receiving the reply packet until one of: receiving, by the reconnaissance detection device, a stop instruction from the external device, and elapsing of a predetermined period of time after transmission of a request packet to the specific networked device without receipt of a reply packet from the specific networked device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for detecting, alerting, and interference with network reconnaissance in accordance with exemplary embodiments.

FIG. 2 is a block diagram illustrating the reconnaissance detection device of the system of FIG. 1 for the detecting, alerting, and interfering with network reconnaissance in accordance with exemplary embodiments.

FIG. 3 is a flow diagram illustrating a process 300 for the identification of unknown networked devices using the reconnaissance detection device of FIG. 2 in accordance with exemplary embodiments.

FIG. 4 is a flow diagram illustrating a process 400 for detecting unauthorized network activity by the reconnaissance detection device of FIG. 2 in accordance with exemplary embodiments.

FIG. 5 is a flow chart illustrating a method 500 for detecting unauthorized network activity in accordance with exemplary embodiments.

FIG. 6 is a flow chart illustrating a method 600 for identifying unknown networked devices in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Detection of Unauthorized Network Reconnaissance

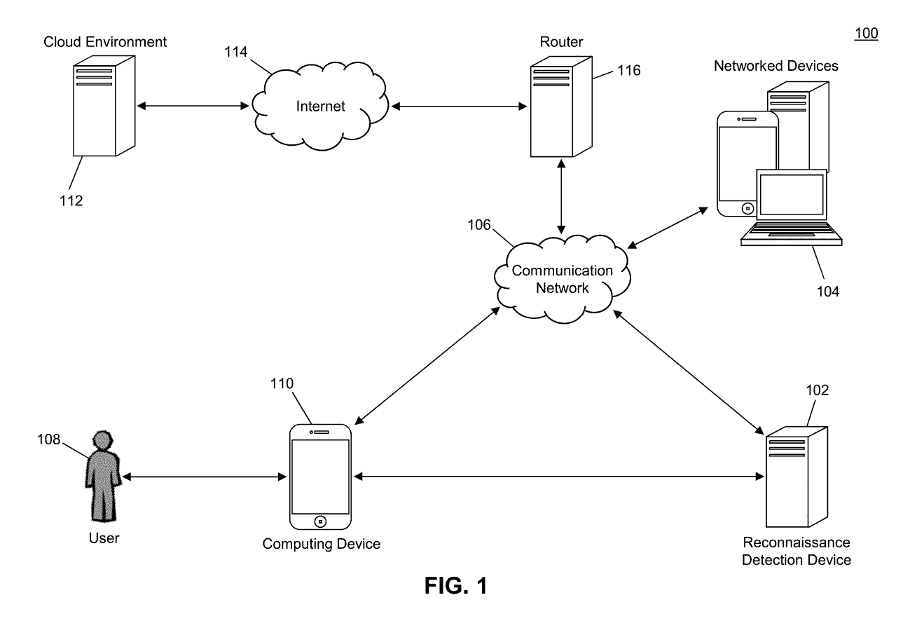

FIG. 1 illustrates a system 100 for the detection of, alerting of, and interference with unauthorized reconnaissance of a computing network.

The system 100 may include a reconnaissance detection device 102, discussed in more detail below. The reconnaissance detection device 102 is designed to detect, alert and interfere with adversaries at the very first stage of the attack cycle—Reconnaissance. While most solutions utilize either signatures of known bad software and/or network traffic, or by utilizing machine learning on endpoints, the reconnaissance detection device 102 can take a novel approach at detecting threats and adding to defense in depth strategies. The reconnaissance detection device 102 accomplishes this detection, alerting and interference by combining several techniques to achieve the following goals: detect reconnaissance activity on network systems (e.g., unauthorized devices connecting to the network, network scanning activity, unauthorized and new network services, interaction with deception based network defenses, etc.); utilize a small, unobtrusive hardware device that will work with a vast majority (it not all) network setups, routers, access points, etc.; provide a simple to configure device that is as plug and play as possible; send alerts via email or other suitable communication method (e.g., short messaging service message (SMS), multimedia messaging service message (MMS), etc.) when reconnaissance activity is detected; utilize active countermeasures to disrupt the communications of unauthorized devices or devices exhibiting reconnaissance behavior; and utilize a simple, intuitive, cloud hosted web interface to manage the device.

Current advanced cyber defense devices and applications are usually very technical and are built for advanced technical individuals and analysts. Conversely, the reconnaissance detection device 102 is technical on the back end, but intuitive and easy to use on the front end for non-technical users, such as a user 108 that may utilize the reconnaissance detection device 102 to protect their communication network 106 from such an attack. In some cases, the solution provided by the reconnaissance detection device 102 may include the implementation of a secure API (application program interface) between the device 102 and a cloud environment 112 to allow for updates, analysis, registration, and licensing. In such cases, the services provided by the reconnaissance detection device 102 may be scaled to hundreds of thousands of users 104.

The system 100 may be comprised of a number of components, such as illustrated in FIG. 1. The reconnaissance detection device 102, as discussed in more detail below, may be a hardware device that is installed in the field (e.g., at or near a physical location of the communication network 106). The reconnaissance detection device 102 may have a unique device identifier associated therewith, which may be registered via the secure API. The device identifier may be a unique value suitable for identification of the reconnaissance detection device 102, such as a media access control address, registration number, serial number, etc. The reconnaissance detection device 102 may establish a secure communication channel with the cloud environment 108 and/or an API server, which may be included in or external to the cloud environment 108. The reconnaissance detection device 102 may be configured to inventory all devices operating on the communication network 106, identify unknown devices, utilize cyber deception traps, apply active countermeasures, provide real-time alerts to users 104 (e.g., via e-mail, short messaging service, multimedia messaging service, push notification, etc.), log network activity performed on the communication network 106, and provide system updates. The reconnaissance detection device 102 may utilize any suitable programming language and operating system, such as a combination of Python programming and a Linux/Unix shell.

The cloud environment 108 may utilize cloud server infrastructure designed to be able to scale both vertically (e.g., using additional hardware resources in the existing servers 108) and horizontally (e.g., adding additional servers 108 as load/demand is increased). In some embodiments, the cloud environment 108 may be comprised of at least four servers: an API server, a database server, a webserver, and a communication server.

The API server may use any suitable programming language and operating system, such as Python for programming using a suitable web framework and an Ubuntu Linux operating system. The API server may provide an interface for the reconnaissance detection device 102 to send/receive information securely (e.g., via AES-128 with SHA-1 HMAC encryption or other suitable encryption algorithms) for control of the reconnaissance detection device 102 and display of data associated therewith, such as to a computing device 110 utilized by the user 108. For instance, the computing device 110 may be configured to contact the API server (e.g., through the internet 114) to receive such data for display to the user 108. Such a computing device 110 may be any type of suitable computing device, such as a desktop computer, laptop computer, notebook computer, tablet computer, cellular phone, smart phone, smart watch, smart television, etc. The API server may be configured to check authorization of the reconnaissance detection device 102, provide for authentication of communications to/from the reconnaissance detection device 102, provide for the storage and acknowledgement of real-time status and system level interactive functions of the reconnaissance detection device 102, and provide a mechanism for updating the reconnaissance detection device 102 remotely, such as to introduce bug fixes, new functionality, firmware upgrades, etc., and to acknowledge proper execution of such updates. The API server may also be configured to provide commands for command and control functions of software executed by the reconnaissance detection device 102 (e.g., for operation by a user 108), provide a mechanism for the reconnaissance detection device 102 to query the database server (e.g., providing network devices, ports, connection status, etc.), provide a channel through which the reconnaissance detection device 102 can transmit alerts, provide a mechanism for the reconnaissance detection device 102 to insert new devices, modify devices, insert new network ports, delete network ports, modify information on network ports, etc., provide a mechanism for the reconnaissance detection device 102 to send logs and alerts to the database server, perform pre-registration and initialization of the reconnaissance detection device 102, and additional services that may be necessary for the performing of the functions of the reconnaissance detection device 102 as discussed herein.

The database server may be a server that provides back end database functionality to the API server, webserver, communication server, and may also store data and other information provided by the reconnaissance detection device 102. The database server may utilize any suitable type of database architecture, including a relational database. The webserver may provide for an interface via the Internet 118 through which the user 108 may interact with (e.g., using the computing device 110) the reconnaissance detection device 102. The webserver may use any suitable type of server software and may provide for registration of users 104, registration of reconnaissance detection devices 102, and the interface through which the user 108 may access, control, and utilize the functions of the reconnaissance detection device 102 as discussed herein. In some cases, the webserver may store its non-volatile data in the database server 112. The communication server may provide a channel for electronic transmissions from the reconnaissance detection device 102 to outside computing systems, such as for sending alerts via e-mail, SMS, MMS, or other suitable method. In such cases, the reconnaissance detection device 102 may be configured to communicate only with the cloud environment 108 outside of the communication network 106, where any data to be transmitted from the reconnaissance detection device 102 to a device outside of the cloud environment 108 may be routed through a router 116.

In some embodiments, the reconnaissance detection device 102 may be configured to assist a user 108 in the identification of devices in the network 106. Such a function may be beneficial in larger communication networks 106 or in communication networks 106 where there may be one or more devices that a user 108 cannot readily identify. In such an embodiment, the user 108 may access an interface of the reconnaissance detection device 102 that is configured to display each of the devices connected to the communication network 106 as detected by the reconnaissance detection device 102. The interface may be access via an additional device (e.g., the computing device 110, etc.) that is in communication with the reconnaissance detection device 102 (e.g., directly, such as through Bluetooth or near field communication or via the communication network 106) or directly via the reconnaissance detection device 102 if a display device or other interactable interface is interfaced therewith. As discussed herein, the use of an “external device” to interact with the reconnaissance detection device 102 may refer to a computing device 110 or an interface of the reconnaissance detection device 102.

Using the reconnaissance detection device 102, the user 108 may view a list of all of the networked devices 104 that are currently detected as being connected to the communication network 106 by the reconnaissance detection device 102. From the list of networked devices 104, the user 108 may select a device for identification. For instance, the user 108 may be presented with several networked devices 104 on their home network but may not recognize which is which in the displayed list, due to available identification data. For example, the user 108 may be unaware of media access control (MAC) addresses and network identification information for each networked device 104, while still being aware of the network-connected devices in their home. The user 108 may select a device for identification using the interface provided with the reconnaissance detection device 102. For example, the user 108 may have a smart phone (e.g., the computing device 110) that has an application program stored therein and executed thereby that enables the user 108 to view the list of networked devices 104 and select a networked device 104 for identification through the reconnaissance detection device 102.

Once the device is selected for identification, the reconnaissance detection device 102 may electronically transmit a ping to the selected networked device 104. In some embodiments, the ping may be an internet control message protocol (ICMP) type 8 echo request packet that is electronically transmitted to the device via an internet protocol (IP) address of the device. The networked device 104 may receive the packet and may respond with an ICMP type 0 echo reply packet back to the reconnaissance detection device 102 via the communication network 106. The reconnaissance detection device 102 may continue to ping the selected networked device 104 and await reply from the networked device 104. The pings may be transmitted periodically at a predetermined interval, such as one ping every second. While the networked device 104 is being pinged, the user 108 may be instructed (e.g., via a display in the application program of the computing device 110) to power down or otherwise disconnect networked devices 104 from the network 106. While the user 108 performs these actions, the reconnaissance detection device 102 may continue to ping the selected networked device 104.

If the predetermined interval goes by without a reply being received by the reconnaissance detection device 102 from the selected networked device 104, the reconnaissance detection device 102 may electronically transmit a second ICMP type 8 echo request along with at least one of: an address resolution protocol (ARP) request, a transmission control protocol (TCP) synchronize (SYN) packet (e.g., to port 443), a TCP acknowledge (ACK) packet (e.g., to port 80), and an ICMP timestamp request. If the selected networked device 104 replies to any of these additional packets, the reconnaissance detection device 102 may determine that the networked device 104 is still connected to the network 106 and the period pinging may continue.

If the selected networked device 104 fails to respond to any of the packets, then the reconnaissance detection device 102 may determine that the selected device has been removed from the communication network 106. The user 108 may then be presented (e.g., via their application program or other interface being used) with a message indicating that the networked device 104 they recently disconnected from the network 106 is the selected networked device 104. In some cases, the user 108 may be prompted with one or more input fields to supply a name or other information regarding the selected networked device 104, such as for use by the user 108 in later instances when viewing the networked devices 104 connected to the network 106. The user 108 may repeat the process to have every networked device 104 properly identified. The reconnaissance detection device 102 may be configured to store data associations between networked devices 104 (e.g., represented by a device identifier or other identifying information identified via the reconnaissance detection device) and names supplied by a user 108. In instances where a name for a networked device 104 has been identified, data displays on the computing device 110 (e.g., via the API server, webserver, etc.) for networked devices 104 may use the supplied name in place of, or in conjunction with, the device identifier.

### Reconnaissance Detection Device

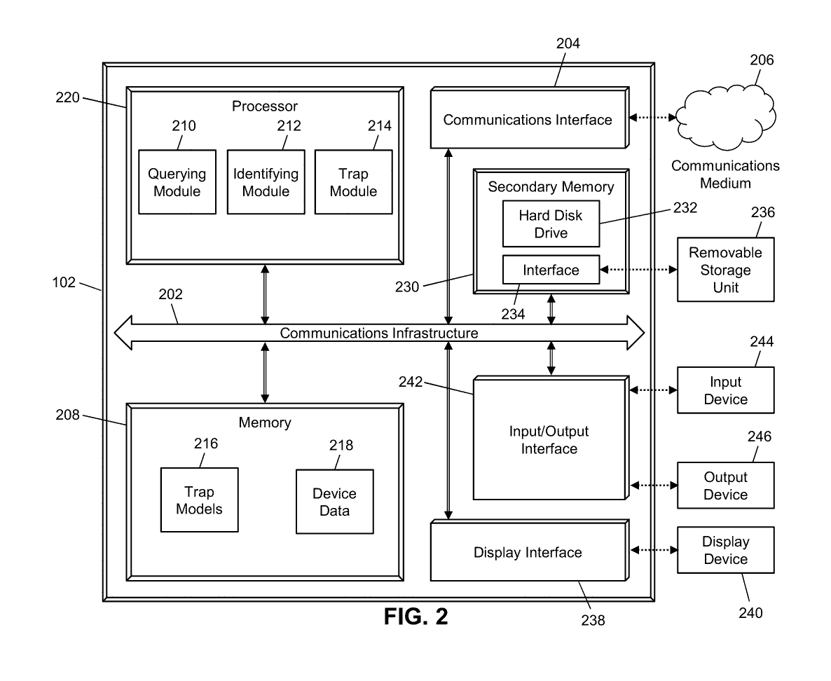

FIG. 2 illustrates an embodiment of the reconnaissance detection device 102 in the system 100. It will be apparent to persons having skill in the relevant art that the embodiment of the reconnaissance detection device 102 illustrated in FIG. 2 is provided as illustration only and may not be exhaustive to all possible configurations of the reconnaissance detection device 102 suitable for performing the functions as discussed herein.

The reconnaissance detection device 102 may include a communications infrastructure 202. The communications infrastructure 202 may be configured to transmit data between modules, engines, databases, memories, and other components of the reconnaissance detection device 102 for use in performing the functions discussed herein. The communications infrastructure 202 may be comprised of one or more communication types and utilize various communication methods for communications within a computing device. For example, the communications infrastructure 202 may be comprised of a bus, contact pin connectors, wires, etc. In some embodiments, the communications infrastructure 202 may also be configured to communicate between internal components of the reconnaissance detection device 102 and external components of the reconnaissance detection device 102, such as externally connected databases, display devices, input devices, etc.

The reconnaissance detection device 102 may also include a communications interface 204. The communications interface 204 may include one or more interfaces used to interact with and facilitate communications between the reconnaissance detection device 102 and one or more external devices via suitable communications mediums 206, such as to the cloud environment 108 or computing device 110 via the communication network 106. For instance, the communications interface 204 may interface with the communications infrastructure 202 and provide an interface 204 for connecting the reconnaissance detection device 102 to one or more communications mediums 204 for the electronic transmission or receipt of data signals that are encoded or otherwise superimposed with data for use in performing the functions discussed herein. Communications interfaces 204 may include universal serial bus (USB) ports, Personal Computer Memory Card International Association (PCMCIA) ports, PS/2 ports, serial ports, fiber optic ports, coaxial ports, twisted-pair cable ports, wireless receivers, etc. Communications mediums 206 may include local area networks, wireless area networks, cellular communication networks, the Internet, radio frequency, Bluetooth, near field communication, etc.

In some instances, the reconnaissance detection device 102 may include multiple communications interfaces 204 for electronically transmitting and receiving data signals via one or more communications mediums 206, such as a first communications interface 204 configured to transmit and receive data signals via a local area network and a second communications interface 204 configured to transmit and receive data signals via the Internet 114. In some instances, the communications interface 204 may include a parsing module for parsing received data signals to obtain the data superimposed or otherwise encoded thereon. For example, the communications interface 204 may include (e.g., or otherwise have access to, such as via the communications infrastructure 204) a parser program configured to receive and transform the received data signal into usable input for the functions performed by the processing device to carry out the methods and systems described herein.

The communications interface 204 may be configured to receive data signals electronically transmitted by the API server, which may be superimposed or otherwise encoded with firmware updates, user instructions, countermeasure updates, etc. The communications interface 204 may also be configured to electronically transmit data signals to the API server, which may be superimposed or otherwise encoded with alerts to be transmitted via e-mail, SMS, MMS, or other suitable communication method, such as by the router 116. The communications interface 204 may also be configured to electronically transmit data signals to and receive data signals electronically transmitted from a computing device 110, either directly, via the communications network 106, or via the Internet 114. Such data signals may be superimposed or otherwise encoded with data used in the identification of unknown networked devices 104. The communications interface 204 may also be configured to receive data signals electronically transmitted by and electronically transmit data signals to networked devices 104 (e.g., via the communication network 106), such as pings, replies, and other packet messages or network activity.

The reconnaissance detection device 102 may also include a memory 208. The memory 208 may be configured to store data for use by the reconnaissance detection device 102 in perform the functions discussed herein. The memory 208 may be comprised of one or more types of memory using one or more suitable types of memory storage, such as random access memory, read-only memory, hard disk drives, solid state drives, magnetic tape storage, etc. For instance, in one example, the memory 208 may be comprised of at least 8 gigabytes of embedded multimedia controller or micro secure digital memory. The memory 208 may store data in any suitable type of configuration, such as in one or more lists, databases, tables, etc., which may store the data in a suitable data format and schema. In some instances, the memory 208 may include one or more relational databases, which may utilize structured query language for the storage, identification, modifying, updating, accessing, etc. of structured data sets stored therein. The memory 208 may be configured to store, for instance, operating code, alert definitions, an active network inventory, a network scan detection engine, etc.

The memory 208 may also include, for example one or more trap models 216. Trap models 216 may be used by the reconnaissance detection device 102 to detect unauthorized network activity on the communication network 106. Trap models may be executed by the reconnaissance detection device to emulate known devices, such as other networked devices 104 or similar types of computing devices, where unauthorized network activity may be transmitted to the emulated device for use in identifying unauthorized network activity and devices. The memory 208 may also include device data 218. The device data 218 may include data associated with networked devices 104 interfaced with the communication network 106. Such data may include device identifiers, network addresses, names supplied by a user 108, port forwarding data, or any other suitable data.

The reconnaissance detection device 102 may also include a processor 220. The processor 220 may be configured to perform the functions of the reconnaissance detection device 102 discussed herein as will be apparent to persons having skill in the relevant art. In some embodiments, the processor 220 may include and/or be comprised of a plurality of engines and/or modules specially configured to perform one or more functions of the reconnaissance detection device 102. As used herein, the term “module” may be software or hardware particularly programmed to receive an input, perform one or more processes using the input, and provides an output. The input, output, and processes performed by various modules will be apparent to one skilled in the art based upon the present disclosure. The processor 220 as discussed herein may be a single processor, a plurality of processors, or combinations thereof, which may also include processors that may have one or more processor “cores.” Operations performed by the processor 220 or modules included therein may be performed as a sequential process and/or be performed in parallel, concurrently, and/or in a distributed environment. In some embodiments the order of operations may be rearranged without departing from the spirit of the disclosed subject matter. The processor 220 and the modules or engines included therein may be configured to execute program code or programmable logic to perform the functions discussed herein, such as may be stored in the memory 208 and/or a secondary memory 230, discussed in more detail below. In one example, the processor 220 may be a 64-bit advanced reduced instruction set computer machine (ARM) processor. In some cases, the processor 220 may be a part of a single-board computing device that is specifically configured to perform the functions of the reconnaissance detection device 102 as discussed herein, such as the Odroid C2.

The processor 220 may include, for instance, a querying module 210, identifying module 212, and trap module 214. The querying module 210 may be configured to execute queries on the memory 208 or secondary memory 230 of the reconnaissance detection device 102 to identify data stored therein. For example, the querying module 210 may execute a query on the memory 208 to update device data 218 for a networked device 104 to add a name supplied by a user 108 using the processes discussed herein. The identifying module 212 may be configured to identify data for use by the reconnaissance detection device 102, such as identifying networked devices 104 interfaced with the communication network 106. The trap module 214 may be configured to execute actions associated with trap models 216, such as for emulating a known networked device 104 and receiving network communications associated therewith. In some cases, the emulation of a known networked device may utilize associated ports or other communications components for the receipt of network communications intended for the emulated device.

In some embodiments, the reconnaissance detection device 102 may also include a secondary memory 230. The secondary memory 230 may be another memory in addition to the memory 208 that may be used to store additional data for use in performing the functions of the reconnaissance detection device 102 as discussed herein. In some embodiments, the secondary memory 230 may be a different format or may use a different data storage method and/or schema than the memory 208. The secondary memory 230 may be any suitable type of memory, and, in some instances, may include multiple types of memory. For instance, the secondary memory 230 may be comprised of a hard disk drive 232 and one or more interfaces 234, where the interfaces 234 are configured to transmit data to and receive data from one or more removable storage units 236. Removable storage units 236 may include, for example, floppy disks, compact discs, digital video discs, Blu-ray discs, removable hard drives, flash drives, universal serial bus drives, etc.

In some cases, the reconnaissance detection device 102 may also include a display interface 238. The display interface may be configured to interface the reconnaissance detection device 102 with one or more display devices 240, such as interfaced directly with the reconnaissance detection device 102 or indirectly via a communication method (e.g., the computing device 110). The display devices 240 may be devices configure to display data received from the reconnaissance detection device 102. Display devices 240 may be any suitable type of display, including, for example, liquid crystal displays, light emitting diode displays, thin film transistor display, capacitive touch displays, etc. In some instances, the reconnaissance detection device 102 may include one or more display interfaces 238, which may interface with one or more display devices 240.

The reconnaissance detection device 102 may also include an input/output interface 242. The input/output interface 242 may be configured to interface the reconnaissance detection device 102 with one or more input devices 244 and/or output devices 246 for the transmission to and receipt of data from the respective devices. The input/output interface 242 may include any suitable type of interface, and in some instances may include multiple types of interfaces, such as for interfacing with multiple types of input devices 244 and/or output devices 246. Input devices 244 may include any suitable type of device for inputting data to an reconnaissance detection device 102, such as a keyboard, mouse, microphone, camera, touch screen, click wheel, scroll wheel, remote control, etc.

### Initializing of the Reconnaissance Detection Device and Identification of Devices

The reconnaissance detection device 102 functions are provided by firmware that has been programmed into the system. The firmware may be written in Python 2.7 and utilize rc.init scripts and shell scripts. The main engine in the firmware may be referred to herein as an agent. The agent may be responsible for all system functions in the reconnaissance detection device 102, and may be run as an infinite loop daemon process. For additional protection against agent failure, a Linux CRON job may be used to check to assure the agent is running and restarts it if necessary.

When a new reconnaissance detection device 102 is produced, it may be initialized and pre-registered prior to use by a user 108 (e.g., using the computing device 110). Initialization may be a process used to ensure that the reconnaissance detection device 102 has no residual data on it and that the agent is initialized. Once initialization is done, the agent may then be pre-registered. The pre-registration process may include creation of the device identifier associated with the reconnaissance detection device 102, a password that will be used for access to the reconnaissance detection device 102 database on the database server and for authentication with the API Server, and a Shared Secret that is used for secure communications with the API Server. A Shared Secret is a piece of data (e.g., a password, a passphrase, a big number or an array of randomly chosen bytes) known only to the parties involved in a secure communication. In some cases, when such a process is completed, a device identifier unique to the reconnaissance detection device 102 may be returned to the user 108.

The reconnaissance detection device 102 may then be ready to be put into use, such as by a user 108 connecting the reconnaissance detection device 102 into their communication network 106. Once put onto a communication network 106 and powered on, the reconnaissance detection device 102 will connect to the Internet 114, and establish communications with the API Server. Since the reconnaissance detection device 102 is not yet registered and authorized as operational with the cloud environment 108, the reconnaissance detection device 102 may first look for update commands and will not start any detection or countermeasure services until properly authorized.

The user 108 may be first required to create an account and authenticate via the webserver. Once logged in to the webserver, the user 108 may be prompted to register their reconnaissance detection device 102. The user 108 will type in the device identifier associated with the reconnaissance detection device 102, which, in some instances, may be physically displayed on the reconnaissance detection device 102, such as on a printed label affixed thereto or on the display device 240. Once the device identifier is input, the webserver may check with the database server to ensure that the device identifier is authentic and known by the database server. If the device identifier matches, the webserver may update the database server so that the reconnaissance detection device 102 now belongs to the registered user 108 and that device is now registered and authorized to be operational on the communication network 106.

Once the database server 112 knows the reconnaissance detection device 102 is registered, the next poll of the agent to the API server will show the reconnaissance detection device 102 as authorized, and that it needs to start the initial registration process. The initial registration may start by conducting several levels of network interrogation and inventory with the reconnaissance detection device 102. For instance, such actions may include flushing data stored in the reconnaissance detection device 102 or the database server, performing a first inventory of networked devices 104 in the communication network 106, clearing any existing alerts or similar data in the reconnaissance detection device 102, etc.

Once the inventory is complete, the agent will setup the default traps and bring the user 108 to (e.g., via the webserver and computing device 110) a “Network Inventory” screen, where they will be able to catalog and authorize the networked devices 104 that are on their communication network 106. All changes that are made in the web interface on the webserver are sent as commands to the agent to make changes on the actual reconnaissance detection device 102. Such commands may include, for instance, requests to get updates scripts from the API server, updates to the software or firmware of the reconnaissance detection device 102, updating the trap models 216 in the reconnaissance detection device 102, updating active countermeasures to be used by the reconnaissance detection device 102, stopping one or more actions or operations of the reconnaissance detection device 102, or restarting the reconnaissance detection device 102.

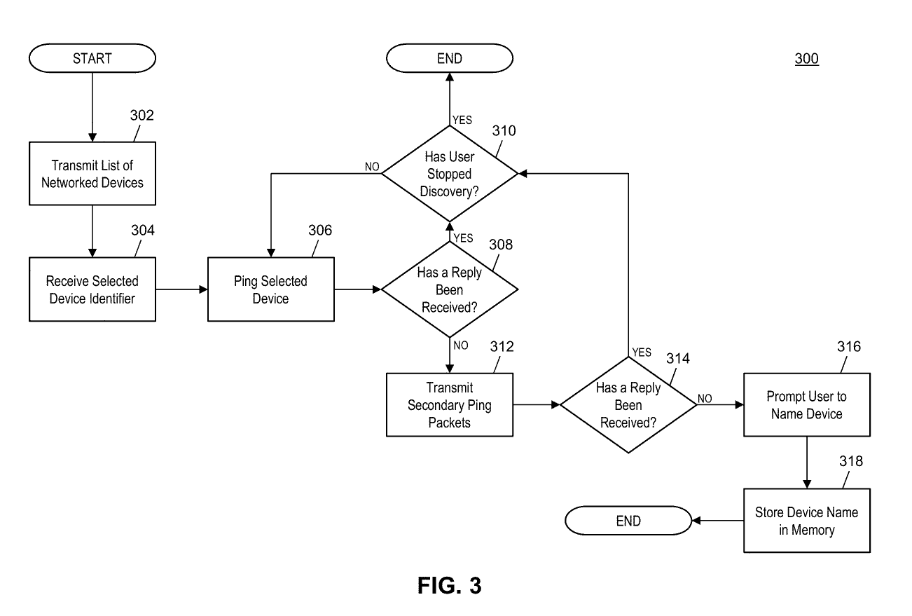

Another such action that may be initiated by the user 108 (e.g., via an instruction submitted using the computing device 110, such as through the webserver or an application program executed on the computing device 110), may be for the identification of networked devices 104, specifically to supply names for each networked device 104. Such an action may be executed by the reconnaissance detection device 102 via the process 300 illustrated in FIG. 3.

In step 302, the communications interface 204 of the reconnaissance detection device 102 may electronically transmit a list of device identifiers for networked devices 104 identified during the inventory process to the user 108, such as via the computing device 110 thereof through the webserver or an application program executed by the computing device 110. The computing device 110 may present the list to the user 108, and the user may select a networked device 104 from the list for identification. In step 304, the communications interface 204 of the reconnaissance detection device 102 may receive the device identifier for the selected networked device 104 from the computing device 110. In some embodiments, the computing device 110 may instruct the user 108 to power down or otherwise interrupt network communications of the selected networked device 104 following the selection thereof.

In step 306, the communications interface 204 may electronically transmit a request packet to the selected networked device 104 as a ping. In step 308, the reconnaissance detection device 102 may determine if a reply packet has been received from the selected networked device 104 within a predetermined period of time. If a reply has been received from the selected networked device 104, then, in step 310, the reconnaissance detection device 102 may determine if an instruction has been received from the computing device 110 supplied by the user 108 to stop the discovery process. If no such instruction has been received, then the process 300 will return to step 306 and continue to ping the selected networked device 104.

If, in step 308, the reconnaissance detection device 102 determines that no reply has been received from the selected networked device 104 within the predetermined period of time, then, in step 312, the communications interface 204 of the reconnaissance detection device 102 may electronically transmit a secondary request packet to the selected networked device 104. In some cases, the secondary request packet may be accompanied by one or more additional packets, such as an ARP request. In step 314, the reconnaissance detection device 102 may determine if a reply has been received from the selected networked device 104 for the secondary request packet or any other accompanying packet, if applicable. If a reply has been received, the process 300 may return to step 310 where the discovery process will continue if not interrupted by the user 108.

If a reply is not received from the selected networked device 104 in a predetermined period of time, which may be the same predetermined period of time for the initial request packet or a different period of time, then, in step 316, the communications interface 204 of the reconnaissance detection device 102 may electronically transmit a prompt to the computing device 110 of the user 108 to supply a name for the selected networked device 104. The lack of a reply received from the selected networked device 104, combined with the instruction to the user 108 to power down or otherwise disable communication capabilities of the selected networked device 104, is such that, when the user 108 powers down the selected networked device 108, the prompt may be received by the computing device 110 and displayed to the user 108. The user 108 may then input a name of the selected networked device 104 that they just powered down, which may be transmitted to the reconnaissance detection device 102. In step 318, the reconnaissance detection device 102 may store the name along with the device identifier for the selected networked device 104 in the memory 208 of the reconnaissance detection device 102, such as part of the device data 218 stored therein.

### Detection and Interference of Unauthorized Network Reconnaissance

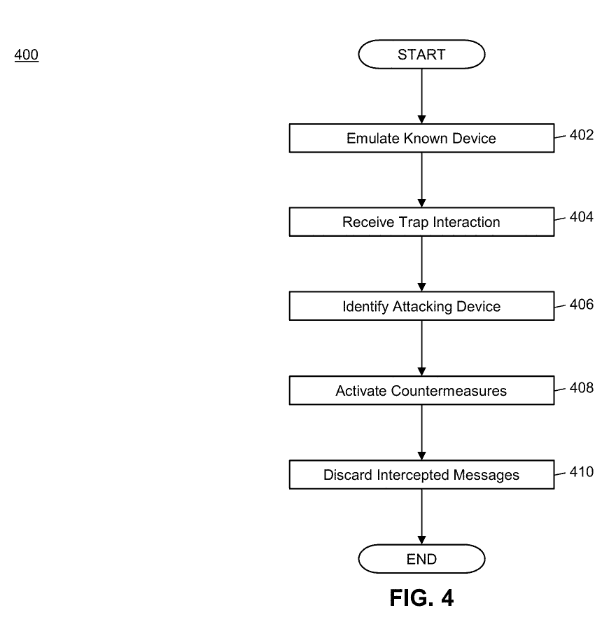

FIG. 4 illustrates a process 400 for operation of the reconnaissance detection device 102 for the detection, trapping, and execution of countermeasures for unauthorized networked devices 104 that are attempting to access or perform reconnaissance of the communication network 106.

Once a reconnaissance detection device 102 has performed an inventory and the user 108 has classified and authorized devices (e.g., identified via the process 300 discussed above), the agent will go into normal run mode. In some embodiments, there are four threads that may run during normal run mode of the agent: Rogue (Unauthorized) Device Detection (RDD), Network Scan Detection (SCAND), Cyber Detection Traps (TRAPD), and Active Countermeasures (AC).

As part of the RDD, the reconnaissance detection device 102 may keep a synchronized inventory of known networked devices 104 (e.g., by tracking IP addresses and MAC addresses found during varying levels of network scans from fast to intense). Once a new networked device 104 is found, the reconnaissance detection device 102 may, by default, determine the new networked device 104 to be a rogue device, and may generate an alert and start (e.g., if enabled) countermeasures against the offending device. In some embodiments, the RDD may be implemented via a combination of Python programs, BASH shell scripts, and Linux system commands. The results (e.g., alerts, logs, devices, device attributes, etc.) of the RDD may be communicated directly to the API server. If communication via the API is not possible, results may be stored locally in the reconnaissance detection device 102 until such a time as API communications are restored. At such a time, results may be synchronized with the API server.

As part of the Network Scan Detection, the reconnaissance detection device 102 may set the network interface of the reconnaissance detection device 102 in what is referred to herein as a “promiscuous” mode to listen for scanning behavior on the network with a SCAND daemon. In some cases, the SCAND daemon may be written in Python. The results of the SCAND process (e.g., alerts, logs, etc.) may be communicated directly to the API server via the API. If communication via the API is not possible, all results may be stored locally in the reconnaissance detection device 102 until such a time as API communications are restored. At such a time, the reconnaissance detection device 102 may synchronize the results of the SCAND process with the API server.

The Cyber Deception Traps process is illustrated in FIG. 4 as the process 400. As part of the TRAPD process 400, the reconnaissance detection device 102 may execute one or more trap models 216 (e.g., via the trap module 214 of the processor 220 thereof) to emulate a known device, which may be one of the other networked devices 104 or similar to one of the networked devices 104. Such emulated devices may include, for instance, network attached storage, security systems, Internet of things devices, etc. The trap model 216 may, in some instances, be utilized by opening a carefully configured network port (or combination of ports, as applicable) on the reconnaissance detection device 102.

In step 404, an attacker may try to interact with a trap, such as may be detected via the receipt of a communication message by the communications interface 204 of the reconnaissance detection device 102 intended for the emulated device. The receipt of the message may trigger an alarm on the reconnaissance detection device 102. In some embodiments, the triggering of the alarm my initiate the sending of an alert to the user 108, such as to the computing device 110 thereof for display thereto using the API or the webserver. In step 406, the reconnaissance detection device 102 may identify the attacking device as one of the networked devices 104, such as by identifying a device identifier included in the communications message data (e.g., in a header), such as a device identifier associated with a source of the communications message.

In step 408, the reconnaissance detection device 102 may then activate one or more countermeasures using the AC process, discussed below. As part of the countermeasures, the reconnaissance detection device 102 may receive all network traffic that is transmitted by the attacking device, which, in step 410, may be discarded by the reconnaissance detection device 102. As a result, any attempted reconnaissance or attack by the attacking device may be thwarted before it can begin. The results of the TRAPD process 400 (e.g., alerts, logs, etc.) may be communicated directly to the API server by the reconnaissance detection device 102. If communication is not possible, the results may be stored locally in the reconnaissance detection device 102 until such communication is restored. At such a time, the reconnaissance detection device 102 may synchronize the results with the API server. In some embodiments, the TRAPD process may be implemented via a Python script.

The AC process may be designed to disrupt the Internet connectivity of devices that are unauthorized or display reconnaissance behavior. Countermeasures may include the performance an “Address Resolution Protocol (ARP) Spoof” on the devices that the reconnaissance detection device 102 determines may be a threat. The reconnaissance detection device 102 may query the communication network 106 to find the default Internet router 116 then flood the threat device with ARP packets that will send all traffic destined for the Internet 114 to the reconnaissance detection device 102, which will then discard it, effectively stopping the threat device from establishing any command and control or data exfiltration channels. In some cases, the AC may be very persistent and will continue to run (even between reboots) until the user 108 stops the AC in the web interface (e.g., provided via the webserver) or application program of the computing device 110 and that command is communicated to the agent via the API server. In some embodiments, the AC may be implemented via Python.

### Exemplary Method for Detecting Unauthorized Network Activity

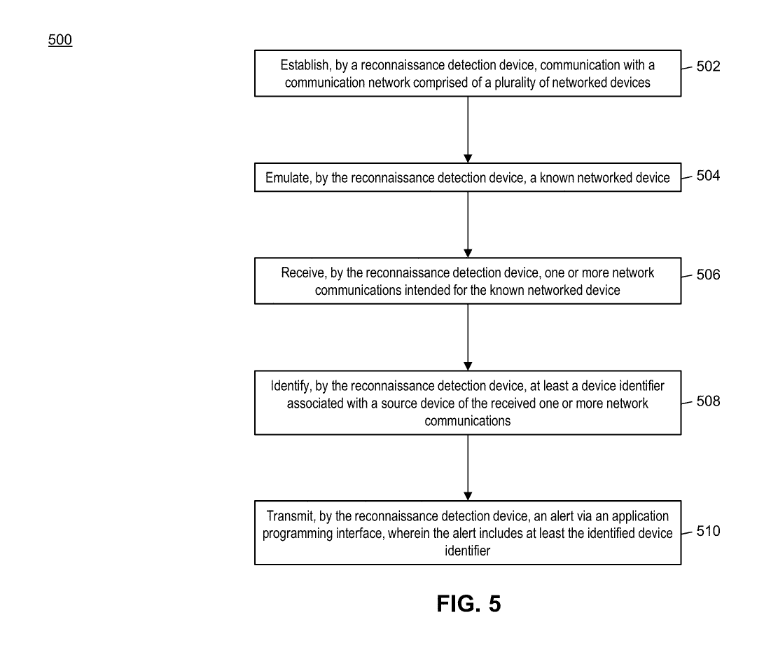

FIG. 5 illustrates a method 500 for the detection and alerting of unauthorized network activity by a networked device in a communication network using a reconnaissance detection device.

In step 502, communication with a communication network (e.g., the communication network 106) may be established by a reconnaissance detection device (e.g., the reconnaissance detection device 102), where the communication network is comprised of a plurality of networked devices (e.g., networked devices 104). In step 504, a known networked device may be emulated by the reconnaissance detection device (e.g., via the trap module 214 of the processor 220 thereof). In step 506, the reconnaissance detection device 102 may receive (e.g., via the communications interface 204) one or more network communications intended for the known networked device.

In step 508, at least the device identifier associated with a source device of the received one or more network communications may be identified by the reconnaissance detection device (e.g., via the identifying module 212 of the processor 220 thereof). In step 510, an alert may be transmitted by the reconnaissance detection device (e.g., via the communications interface 204 thereof) via an application programing interface, wherein the alert includes at least the identified device identifier.

In one embodiment, the method 500 may further include activating, by the reconnaissance detection device, at least one countermeasure action after identifying the device identifier. In a further embodiment, the method 500 may also include transmitting, by the reconnaissance detection device, a plurality of address resolution protocol packets to the source device using the communication network. In an even further embodiment, the method 500 may even further include: receiving, by the reconnaissance detection device, one or more additional network communications transmitted by the source device using the communication network; and discarding, by the reconnaissance detection device, the one or more additional network communications.

### Exemplary Method for Identifying Unknown Networked Devices

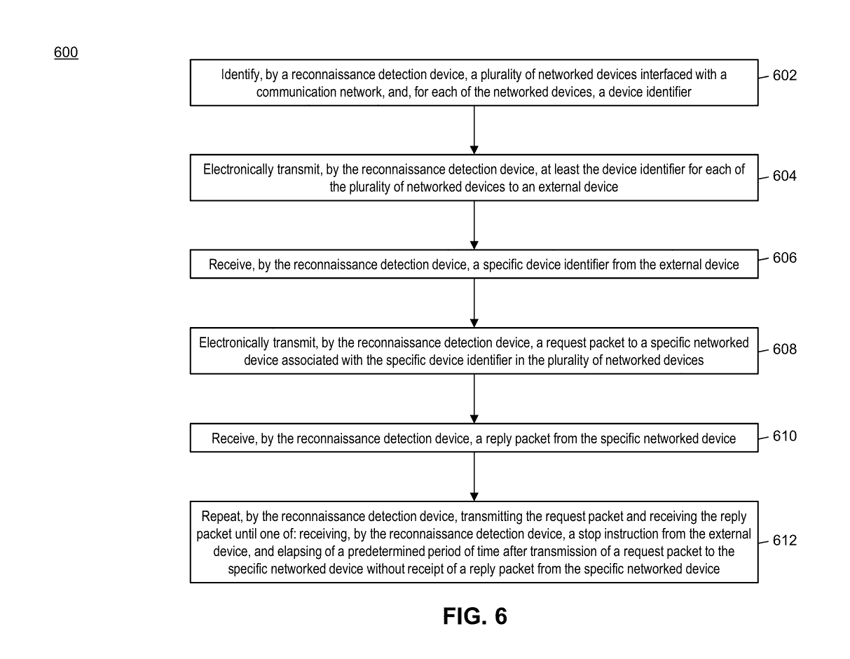

FIG. 6 illustrates a method 600 for the identification and naming of unknown devices interfaced with a communication network using a reconnaissance detection device.

In step 602, a plurality of networked devices (e.g., networked devices 104) interfaced with a communication network (e.g., the communication network 106) may be identified by reconnaissance detection device as well as, for each of the networked devices, a device identifier. In step 604, the reconnaissance detection device may electronically transmit (e.g., via the communications interface 204 thereof) at least the device identifier for each of the plurality of networked devices 104 to an external device (e.g., the computing device 110 or interfacing device part of the reconnaissance detection device).

In step 606, a specific device identifier may be received by the reconnaissance detection device (e.g., via the communications interface 204 thereof) from the external device. In step 608, a request packet may be electronically transmitted by the reconnaissance detection device to a specific networked device associated with the specific device identifier in the plurality of networked devices.

In step 612, a reply packet may be received by the reconnaissance detection device from the specific networked device. In step 612, the reconnaissance detection device may continue to repeat steps 608 and 610 until one of: the reconnaissance detection device receives a stop instruction from the external device; and a predetermined period of time elapses after transmission of a request packet to the specific networked device without receipt of a reply packet from the specific networked device.

In one embodiment, the method 600 may further include electronically transmitting, by the reconnaissance detection device, a prompt to the external device for a name for the specific networked device if the predetermined period of time elapsed. In a further embodiment, the method 600 may also include: receiving, by the reconnaissance detection device, a device name from the external device; and storing, in a memory (e.g., the memory 208) of the reconnaissance detection device, an association between the device name and the specific device identifier. In some embodiments, the method 600 may further include electronically transmitting, by the reconnaissance detection device, a secondary request packet and an accompanying data packet to the external device if the predetermined period of time elapsed.

Techniques consistent with the present disclosure provide, among other features, systems and methods for detection, alerting, and interfering with unauthorized network reconnaissance. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for detecting unauthorized network activity, comprising:
establishing, by a reconnaissance detection device, communication with a communication network comprised of a plurality of networked devices;
emulating, by the reconnaissance detection device, a known networked device;
receiving, by the reconnaissance detection device, one or more network communications intended for the known networked device;
identifying, by the reconnaissance detection device, at least a device identifier associated with a source device of the received one or more network communications; and
transmitting, by the reconnaissance detection device, an alert via an application programming interface, wherein the alert includes at least the identified device identifier.

2. The method of claim 1, further comprising:
activating, by the reconnaissance detection device, at least one countermeasure action after identifying the device identifier.

3. The method of claim 2, further comprising:
transmitting, by the reconnaissance detection device, a plurality of address resolution protocol packets to the source device using the communication network.

4. The method of claim 3, further comprising:
receiving, by the reconnaissance detection device, one or more additional network communications transmitted by the source device using the communication network; and
discarding, by the reconnaissance detection device, the one or more additional network communications.

5. A method for identifying unknown networked devices, comprising:
identifying, by a reconnaissance detection device, a plurality of networked devices interfaced with a communication network, and, for each of the networked devices, a device identifier;
electronically transmitting, by the reconnaissance detection device, at least the device identifier for each of the plurality of networked devices to an external device;
receiving, by the reconnaissance detection device, a specific device identifier from the external device;
electronically transmitting, by the reconnaissance detection device, a request packet to a specific networked device associated with the specific device identifier in the plurality of networked devices;
receiving, by the reconnaissance detection device, a reply packet from the specific networked device; and
repeating, by the reconnaissance detection device, transmitting the request packet and receiving the reply packet until one of:
receiving, by the reconnaissance detection device, a stop instruction from the external device, and
elapsing of a predetermined period of time after transmission of a request packet to the specific networked device without receipt of a reply packet from the specific networked device.

6. The method of claim 5, further comprising:
electronically transmitting, by the reconnaissance detection device, a prompt to the external device for a name for the specific networked device if the predetermined period of time elapsed.

7. The method of claim 6, further comprising:
receiving, by the reconnaissance detection device, a device name from the external device; and
storing, in a memory of the reconnaissance detection device, an association between the device name and the specific device identifier.

8. The method of claim 5, further comprising:
electronically transmitting, by the reconnaissance detection device, a secondary request packet and an accompanying data packet to the external device if the predetermined period of time elapsed.

9. A system for detecting unauthorized network activity, comprising:
a communication network;
a plurality of networked devices interfaced with the communication network; and
a reconnaissance detection device configured to
establish communication with a communication network comprised of a plurality of networked devices,
emulate a known networked device,
receive one or more network communications intended for the known networked device,
identify at least a device identifier associated with a source device of the received one or more network communications, and
transmit an alert via an application programming interface, wherein the alert includes at least the identified device identifier.

10. The system of claim 9, wherein the reconnaissance detection device is further configured to activate at least one countermeasure action after identifying the device identifier.

11. The system of claim 10, wherein the reconnaissance detection device is further configured to transmit a plurality of address resolution protocol packets to the source device using the communication network.

12. The system of claim 11, wherein the reconnaissance detection device is further configured to
receive one or more additional network communications transmitted by the source device using the communication network, and
discard the one or more additional network communications.

13. A system for identifying unknown networked devices, comprising:
a communication network;
a plurality of networked devices interfaced with the communication network; and
a reconnaissance detection device configured to
identify the plurality of networked devices interfaced with the communication network, and, for each of the networked devices, a device identifier,
electronically transmit at least the device identifier for each of the plurality of networked devices to an external device,
receive a specific device identifier from the external device,
electronically transmit a request packet to a specific networked device associated with the specific device identifier in the plurality of networked devices,
receive a reply packet from the specific networked device, and
repeat transmitting the request packet and receiving the reply packet until one of:
receiving, by the reconnaissance detection device, a stop instruction from the external device, and
elapsing of a predetermined period of time after transmission of a request packet to the specific networked device without receipt of a reply packet from the specific networked device.

14. The system of claim 13, wherein the reconnaissance detection device is further configured to electronically transmit a prompt to the external device for a name for the specific networked device if the predetermined period of time elapsed.

15. The system of claim 14, wherein the reconnaissance detection device is further configured to
receive a device name from the external device, and
store, in a memory of the reconnaissance detection device, an association between the device name and the specific device identifier.

16. The system of claim 13, wherein the reconnaissance detection device is further configured to electronically transmit a secondary request packet and an accompanying data packet to the external device if the predetermined period of time elapsed.
